(19) United States
(12) Patent Application Publication
(10) Pub. No.: US 2006/0050327 A1
(43) Pub. Date: Mar. 9, 2006

(54) Scanner and an image forming apparatus having the same

(76) Inventor: Jeong-pil Lim, Seongnam-si (KR)

Correspondence Address: Stanzione & Kim, LLP, 1740 N ST., NW, 1st Fl., Washington, DC, 20036, US

(21) Appl. No.: 11/201,154

(22) Filed: Aug. 11, 2005

(30) Foreign Application Priority Data
Sep. 4, 2004 (KR) 2004-70663

(51) Int. Cl. H04N 1/04

(52) U.S. Cl. 358/474

(57) ABSTRACT

A scan unit includes a scan frame having a document tray to position a document thereon, a reading sensor movably disposed under the document tray to read the document, a bracket to support the reading sensor, a guide shaft to guide the movement of the reading sensor, and a ground unit to pass electromagnetic energy generated from the reading sensor to the scan frame. The ground unit electrically connects the bracket and the guide shaft.

### CROSS-REFERENCE TO RELATED APPLICATIONS

This application claims the benefit of Korean Patent Application No. 2004-70663, filed Sep. 4, 2004 in the Korean Intellectual Property Office, the disclosure of which is incorporated herein in its entirety by reference.

### BACKGROUND OF THE INVENTION

1. Field of the Invention

The present general inventive concept relates to a scan unit to read images of a document. More particularly, the present general inventive concept relates to a scan unit to be mounted in an image forming apparatus, such as a multi-function office machine or a copy machine, and an image forming apparatus having the same.

2. Description of the Related Art

FIGS. 1 and 2 illustrate a conventional scan unit for an image forming apparatus, such as a copy machine, comprising a scan frame 2 including a document tray for stacking documents thereon, a reading sensor assembly 3 that moves under the document tray to read the documents, and a guide shaft 4 for guiding the movement of the reading sensor assembly 3.

The reading sensor assembly 3 comprises a reading sensor 3a, a bracket 3b for supporting the reading sensor 3a, and a guide member 3c attached to the bracket 3b and having a hole for insertion of the guide shaft 4 therethrough.

The bracket 3b may be made of metal which can achieve a thin formation without being easily transformed. The guide member 3c is typically made by molding of plastic. Generally, the guide shaft 4 is made of metal to maintain straightness.

In the conventional scan unit as described above, the reading sensor assembly 3 moves along the guide shaft 4 upon receiving a scan signal and reads image information of the documents put on the document tray. In FIG. 2, a reference numeral 5 denotes a signal input/output line that carries the scan signal.

In the conventional scan unit, however, electromagnetic waves generated from the reading sensor 3a may be induced to the bracket 3b. Additionally, the bracket 3b can serve as a radiation antenna for specific frequencies, and this may increase radiation of the electromagnetic waves at the specific frequencies and cause an electromagnetic interference (EMI) property of the image forming apparatus to deteriorate. In other words, these specific frequencies of electromagnetic waves may negatively affect performance of components in the image forming apparatus.

As an alternative, the bracket 3b can be formed by molding of plastic. However, this is not recommended, since the structure described above is not space-effective since plastic may be easily deformed, and therefore the thickness of the bracket 3b must be increased to prevent easy transformation thereof.

### SUMMARY OF THE INVENTION

The present general inventive concept provides a scan unit capable of improving an electromagnetic interference (EMI) property of an image forming apparatus by passing a component of electromagnetic energy generated at a reading sensor to a grounded frame of a main body of the image forming apparatus.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a scan unit comprising a scan frame having a document tray to position a document thereon, a reading sensor movably disposed under the document tray to read the document, a bracket to support the reading sensor, a guide shaft to guide the movement of the reading sensor, and a ground unit to pass electromagnetic energy generated from the reading sensor to the scan frame.

The reading sensor and the bracket may be formed as one body, and the bracket may have a guide member to insert the guide shaft therethrough.

The ground unit may comprise a grounding wire connected to the bracket at one end thereof and to connect to the guide shaft by another end thereof, and the guide shaft extends through the guide member.

The guide shaft and the guide member may be made of metal and the ground unit may electrically connect the guide member and the guide shaft by interposing a conductive grease at a contact between the guide member and the guide shaft.

The foregoing and/or other aspects and advantages of the present general inventive concept are also achieved by providing an image forming apparatus comprising a scan unit to read a document, an image forming unit to produce an image using information from the read document, and a main body frame to support the scan unit and the image forming unit, wherein the scan unit comprises: a document tray to position a document thereon, a reading sensor movably disposed under the document tray to read the document, a bracket to support the reading sensor, a guide shaft to guide the movement of the reading sensor, and a ground unit to electrically connect the bracket and the guide shaft.

The foregoing and/or other aspects and advantages of the present general inventive concept are also achieved by providing an image forming apparatus comprising a scan unit to read a document, an image forming unit to produce an image using information from the read document, and a main body frame to support the scan unit and the image forming unit, wherein the scan unit comprises: a document tray to position a document thereon, a reading sensor movably disposed under the document tray to read the document, a bracket to support the reading sensor, a guide shaft to guide the movement of the reading sensor, a first ground unit to electrically connect the bracket and the guide shaft, and a second ground unit to electrically connect the guide shaft and the main body frame.

The bracket may have a guide member to insert the guide shaft therethrough.

The first and the second ground units may comprise grounding wires. A grounding wire of the first ground unit may extend through the guide member to electrically connect the bracket and the guide shaft.

The guide member and the guide shaft may be made of metal and the first ground unit may electrically connect the guide member and the guide shaft by interposing a conductive grease at a contact between the guide member and the guide shaft. The second grounding unit may include a grounding wire.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a drawing schematically illustrating a conventional scan unit;

FIG. 2 is a front view illustrating the conventional scan unit of FIG. 1;

FIG. 3 is a drawing schematically illustrating a scan unit according to an embodiment of the present general inventive concept;

FIG. 4 is a front view illustrating the scan unit of FIG. 3;

FIG. 5 is a front view illustrating a scan unit according to another embodiment of the present general inventive concept; and

FIG. 6 is a drawing schematically illustrating an image forming apparatus having the scan unit according to FIG. 3.

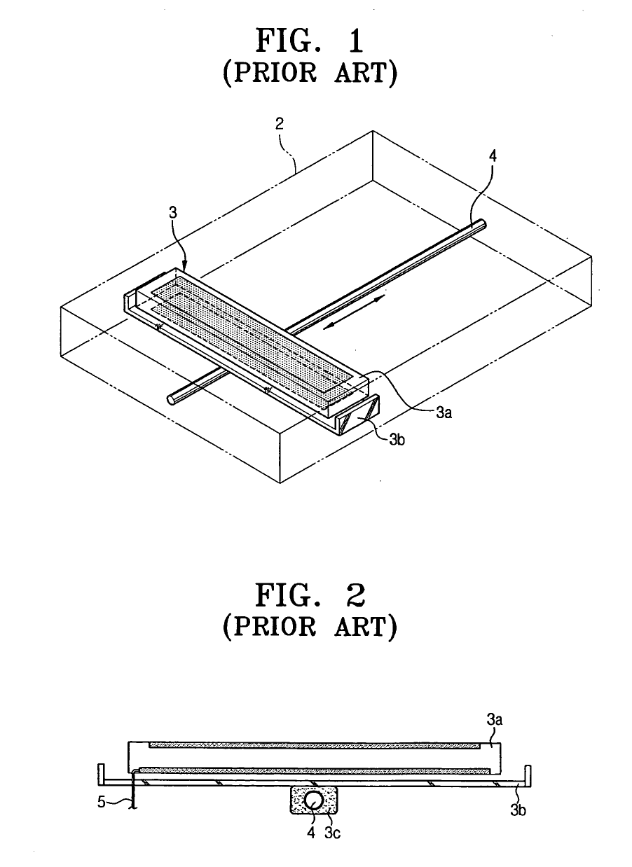

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

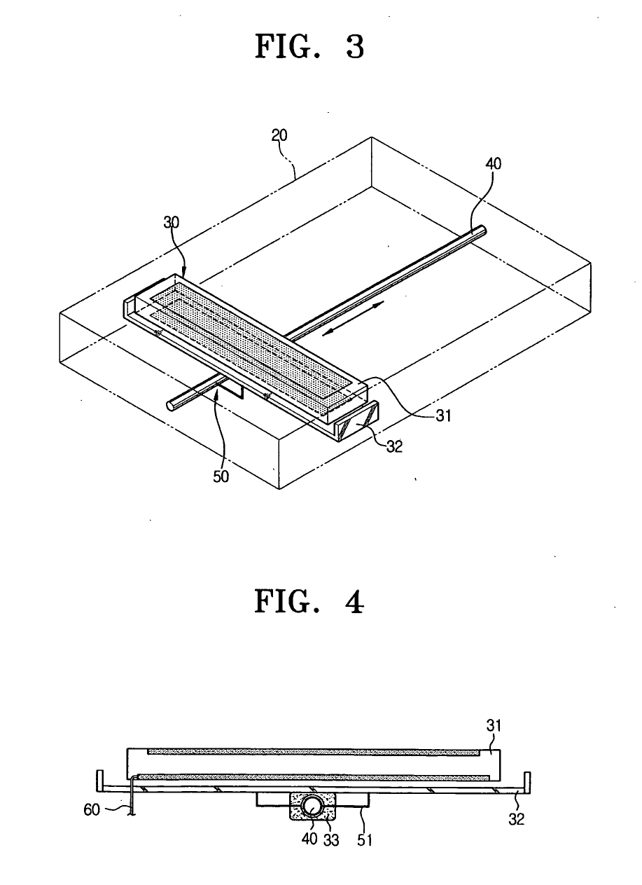

FIGS. 3 and 4 are views schematically illustrating a scan unit according to an embodiment of the present general inventive concept. As illustrated in FIGS. 3 and 4, the scan unit includes a scan frame 20, a reading sensor assembly 30, a guide shaft 40, and a ground unit 50.

The scan frame 20 includes a document tray to position a document thereon. If the scan unit is mounted in an image forming apparatus such as a multi-function office machine, the scan frame 20 may be replaced with a main body frame 200 of the image forming apparatus, as illustrated in FIG. 6.

The reading sensor assembly 30 moves under the document tray in a lengthwise direction of the document tray and reads images of the document positioned on the document tray. The reading sensor assembly 30 comprises a reading sensor 31, a thin metal bracket 32 to support the reading sensor 31, and a guide member 33 (see FIG. 4) disposed below the bracket 32 and formed of a molded plastic molding.

The guide shaft 40 is supported by the scan frame 20 with both ends extending through a hole formed at the guide member 33. The guide shaft 40 guides the movement of the reading sensor assembly 30. The guide shaft 40 is made of metal to maintain straightness.

The ground unit 50 passes a component of electromagnetic energy generated from the reading sensor 31 to the scan frame 20 so that electromagnetic waves are not induced in the metal bracket 32. The ground unit 50 may comprise a grounding wire 51 to electrically connect the bracket 32 and the guide shaft 40.

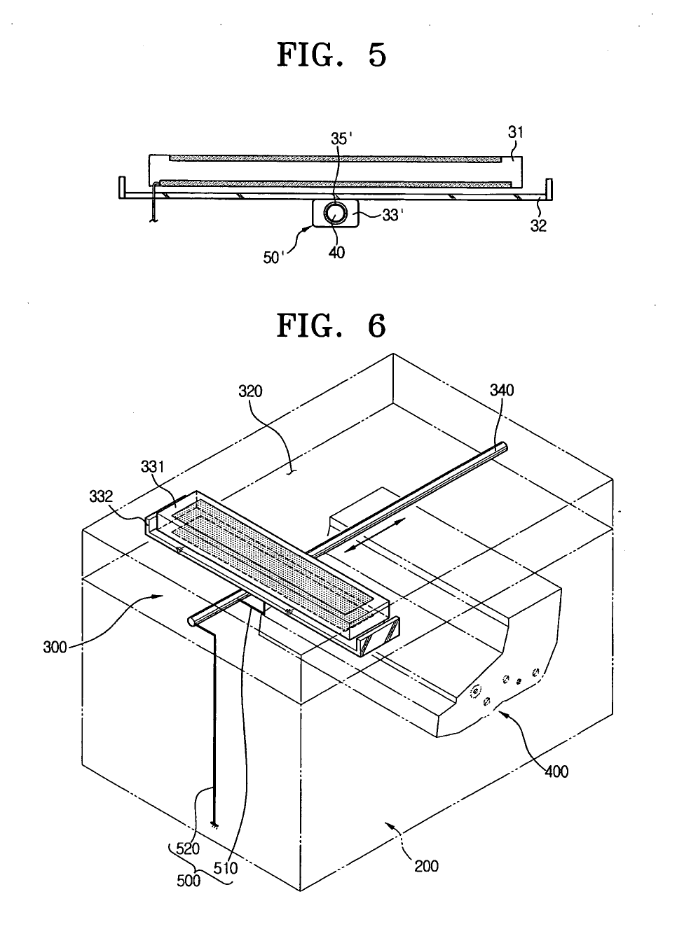

As illustrated in FIG. 5, a ground unit 50′ according to another embodiment of the present general inventive concept may be structured in a manner such that a guide member 33′ is formed of metal, and a conductive grease 35′ is interposed between the guide member 33′ and the guide shaft 40 so that the metal guide member 33′ can be electrically connected to the bracket 32 and the guide shaft 40 via the conductive grease 35′.

Although not illustrated in the drawings, the ground unit may be implemented by any arrangement capable of electrically connecting the bracket 32 and the scan frame 20. For example, the bracket 32 can be directly connected to the scan frame 20 using a wire arranged in a manner that is similar to the manner in which a signal input/output line 60 (see FIG. 4) connects to the reading sensor 31.

Since the bracket 32 that supports the reading sensor 31 is electrically connected with the scan frame 20 in the scan unit according to an embodiment of the present general inventive concept, the bracket 32 functions as a path through which to pass the component of the radiation electromagnetic energy to the scan frame 20, rather than as a radiation antenna, as in the conventional scan unit. Accordingly, electromagnetic interference (EMI) property of the image forming apparatus can be improved.

FIG. 6 is a drawing schematically illustrating an image forming apparatus having the scan unit according to an embodiment of the present general inventive concept. The image forming apparatus includes a main body frame 200, a scan unit 300, an image forming unit 400, and a ground unit 500.

As described hereinbefore, the scan unit 300 comprises a document tray 320, a reading sensor 331, a bracket 332, a guide member (not shown), and a guide shaft 340.

The ground unit 500 passes the electromagnetic energy generated from the scan unit 300 to the main body frame 200. The ground unit 500 may comprise a first ground unit and a second ground unit to electrically connect the bracket 332 and the main body frame 200.

The first ground unit electrically connects the bracket 332 with the guide shaft 340 while the second ground unit electrically connects the guide shaft 340 with the main body frame 200.

In the present embodiment, the first and the second ground units may be implemented using first and second grounding wires 510 and 520. However, other arrangements may also be used as the first and second ground units in the present general inventive concept. For example, as illustrated in FIG. 5, the first ground unit may be implemented by forming the guide member 33′ of metal and interposing the conductive grease 35′ at a contact between the guide member 33′ and the guide shaft 40.

As can be appreciated from the above description, electromagnetic energy generated from a reading sensor during scanning can be passed to a grounded main body frame through a ground unit, and accordingly, an electromagnetic interference (EMI) property of an image forming apparatus can be improved.

Also, according to various embodiments of the present general inventive concept, a bracket made of metal can avoid any problems in the electromagnetic interference (EMI) property of the image forming apparatus. Therefore, structural transformation and deterioration of space-effectiveness can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A scan unit, comprising:
a scan frame including a document tray to position a document thereon;
a reading sensor movably disposed under the document tray to read the document;
a bracket to support the reading sensor;
a guide shaft to guide the movement of the reading sensor; and
a ground unit to electrically connect the bracket and the guide shaft.

2. The scan unit according to claim 1, wherein the reading sensor and the bracket are formed as one body, and the bracket has a guide member to insert the guide shaft therethrough.

3. The scan unit according to claim 2, wherein the ground unit comprises a grounding wire connected to the bracket at one end thereof and connected to the guide shaft at another end thereof while penetrating the guide member.

4. The scan unit according to claim 2, wherein the guide shaft and the guide member are made of metal and the ground unit electrically connects the guide member and the guide shaft by interposing a conductive grease at a contact between the guide member and the guide shaft.

5. A scan unit, comprising:
an electrically grounded scan frame including a document tray to position a document thereon;
a scanning sensor to move along a bottom portion of the document tray to scan the document; and
a bracket to movably support the scanning sensor and electrically grounded to the scan frame to transfer any electromagnetic radiation received from the scanning sensor to the scan frame.

6. The scan unit according to claim 5, wherein the bracket comprises:
a guide shaft connected to opposite sides of the scan frame and extending parallel with a scanning direction of the document; and
a conductive guide member connected to a bottom portion of the bracket and slidable along the guide shaft while transferring the electromagnetic radiation received from the scanning sensor to the guide shaft.

7. The scan unit according to claim 6, wherein the guide member comprises a wire extending therefrom to the bracket.

8. The scan unit according to claim 6, wherein the guide member comprises a conductive grease retained between an inner surface thereof and the guide shaft to transfer electromagnetic radiation from the bracket to the guide shaft.

9. An image forming apparatus, comprising:
a main body frame, which is grounded;
a scanner, comprising:
a document tray on which to place a document;
a scanning sensor assembly movably disposed under the document tray and having a scanning sensor to read the document;
an electromagnetic radiation carrying part to electrically connect the scanning sensor to the main body frame and pass at least a component of electromagnetic radiation generated by the scanning sensor to the grounded main body frame.

10. The apparatus according to claim 9, further comprising:
a scan signal line to carry input and output scan signals between the image forming apparatus and the scanning sensor.

11. The apparatus according to claim 9, wherein the scanning sensor assembly further comprises:
a metal bracket to support the scanning sensor and integrally movable therewith;
a guide rod disposed under the document tray extending along a longitudinal direction of the document tray along which the metal bracket and the scanning sensor are movable; and
a guide member disposed on a bottom surface of the metal bracket opposite the scanning sensor through which the guide rod extends.

12. The apparatus according to claim 11, wherein the guide member is made of plastic.

13. The apparatus according to claim 11, wherein the electromagnetic radiation carrying part comprises a wire to connect the metal bracket to the grounded main body frame.

14. The apparatus according to claim 11, wherein the guide rod is made of metal and the electromagnetic radiation carrying part electrically connects the metal bracket to the guide rod.

15. The apparatus according to claim 14, wherein the electromagnetic radiation carrying part comprises:
a first conductive part to connect the metal bracket to the guide rod; and
a second conductive part to connect the guide rod to the grounded main body frame.

16. The apparatus according to claim 14, wherein the guide member is made of metal and the electromagnetic radiation carrying part comprises a conductive grease interposed between the guide rod and the guide member.

17. The apparatus according to claim 14, wherein the electromagnetic radiation carrying part further comprises:
a conductive part to connect the guide rod to the grounded main body frame.

18. The apparatus according to claim 9, further comprising:
an image forming unit to form an image according to the scanned document.

19. An image forming apparatus comprising a scan unit to read a document, an image forming unit to produce an image using information from the read document, and a main body frame to support the scan unit and the image forming unit, wherein the scan unit comprises:
a document tray to position a document thereon;
a reading sensor movably disposed under the document tray to read the document;
a bracket to support the reading sensor;
a guide shaft to guide the movement of the reading sensor; and
a ground unit to electrically connect the bracket and the guide shaft.

20. The image forming apparatus according to claim 19, wherein the reading sensor and the bracket are formed as one body, and the bracket has a guide member to insert the guide shaft therethrough.

21. The image forming apparatus according to claim 20, wherein the ground unit comprises a grounding wire connected to the bracket at one end thereof and connected to the guide shaft by another end thereof while penetrating the guide member.

22. The image forming apparatus according to claim 20, wherein the guide shaft and the guide member are made of metal and the ground unit electrically connects the guide member and the guide shaft by interposing a conductive grease at a contact between the guide member and the guide shaft.

23. An image forming apparatus comprising a scan unit to read a document, an image forming unit to produce an image using information from the read document, and a main body frame to support the scan unit and the image forming unit, wherein the scan unit comprises:
a document tray to position a document thereon;
a reading sensor movably disposed under the document tray to read the document;
a bracket to support the reading sensor;
a guide shaft to guide the movement of the reading sensor;
a first ground unit to electrically connect the bracket and the guide shaft; and
a second ground unit to electrically connect the guide shaft and the main body frame.

24. The image forming apparatus according to claim 23, wherein the reading sensor and the bracket are formed as one body, and the bracket has a guide member to insert the guide shaft therethrough.

25. The image forming apparatus of claim 24, wherein the first and the second ground units comprise at least one grounding wire.

26. The image forming apparatus of claim 24, wherein the first grounding unit comprises the guide member made of metal and a conductive grease interposed between the guide member and the guide shaft, and the second grounding unit comprises a grounding wire.

27. A method of preventing electromagnetic radiation from negatively affecting performance of an image forming apparatus having a scanner including a document tray on which to place a document and a scanning sensor assembly movably disposed under the document tray to read the document, the method comprising:
electrically connecting a metal bracket that supports a scanning sensor in the scanning sensor assembly to a grounded main body frame of the image forming apparatus.

28. The method according to claim 27, wherein the electrically connecting of the metal bracket to the grounded main body frame of the image forming apparatus comprises:
electrically connecting the metal bracket to a guide rod along which the scanning sensor assembly moves; and
electrically connecting the guide rod to the grounded main body frame of the image forming apparatus.

29. The method according to claim 28, wherein the electrically connecting of the metal bracket to the guide rod comprises interposing conductive grease between the guide rod and a guide member that is disposed on a bottom surface of the metal bracket and through which the guide rod extends.

30. The method according to claim 29, wherein the electrically connecting of the guide rod to the main body frame of the image forming apparatus comprises forming a connection therebetween using a wire.
